(19) United States
(12) Patent Application Publication
(10) Pub. No.: US 2024/0184455 A1
(43) Pub. Date: Jun. 6, 2024

(54) READ TRAINING FOR NON-VOLATILE MEMORY

(71) Applicant: Micron Technology, Inc., Boise, ID (US)

(72) Inventors: Andrea Vigilante, Milano (IT); Riccardo Muzzetto, Arcore (IT)

(21) Appl. No.: 18/513,291

(22) Filed: Nov. 17, 2023

Related U.S. Application Data
(60) Provisional application No. 63/429,405, filed on Dec. 1, 2022.

(51) Int. Cl. G06F 3/06

(52) U.S. Cl. CPC G06F 3/0619; G06F 3/0659; G06F 3/0679

(57) ABSTRACT

Methods, systems, and devices for read training for non-volatile memory are described. In some examples, a memory system may perform read training by receiving a read command and reading a first subset of data. The memory system may apply one or more delays to each byte of the first subset of data and may select a delay for reading a second subset of data. Upon selecting the delay, the memory system may read the second subset of data using the selected delay.

### CROSS REFERENCE

The present Application for Patent claims the benefit of U.S. Provisional Patent Application No. 63/429,405 by VIGILANTE et al., entitled “READ TRAINING FOR NON-VOLATILE MEMORY,” filed Dec. 1, 2022, assigned to the assignee hereof, and expressly incorporated by reference herein.

### TECHNICAL FIELD

The following relates to one or more systems for memory, including read training for non-volatile memory.

### BACKGROUND

Memory devices are widely used to store information in various electronic devices such as computers, user devices, wireless communication devices, cameras, digital displays, and the like. Information is stored by programming memory cells within a memory device to various states. For example, binary memory cells may be programmed to one of two supported states, often corresponding to a logic 1 or a logic 0. In some examples, a single memory cell may support more than two possible states, any one of which may be stored by the memory cell. To access information stored by a memory device, a component may read (e.g., sense, detect, retrieve, identify, determine, evaluate) the state of one or more memory cells within the memory device. To store information, a component may write (e.g., program, set, assign) one or more memory cells within the memory device to corresponding states.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), 3-dimensional cross-point memory (3D cross point), not-or (NOR) and not-and (NAND) memory devices, and others. Memory devices may be described in terms of volatile configurations or non-volatile configurations. Volatile memory cells (e.g., DRAM) may lose their programmed states over time unless they are periodically refreshed by an external power source. Non-volatile memory cells (e.g., NAND) may maintain their programmed states for extended periods of time even in the absence of an external power source.

### BRIEF DESCRIPTION OF THE DRAWINGS

FIG. 1 illustrates an example of a system that supports read training for non-volatile memory in accordance with examples as disclosed herein.

FIG. 2 illustrates an example of a block diagram that supports read training for non-volatile memory in accordance with examples as disclosed herein.

FIG. 3 illustrates an example of a timing diagram that supports read training for non-volatile memory in accordance with examples as disclosed herein.

FIG. 4 illustrates an example of a process flow that supports read training for non-volatile memory in accordance with examples as disclosed herein.

FIG. 5 illustrates a block diagram of a generic device that supports read training for non-volatile memory in accordance with examples as disclosed herein.

FIG. 6 illustrates a flowchart showing a method or methods that support read training for non-volatile memory in accordance with examples as disclosed herein.

### DETAILED DESCRIPTION

Some memory systems may include one or more procedures for improving signal integrity and data sampling. For example, a memory system, such as a not-and (NAND) memory system, may performing calibration operations (e.g., ZQ calibration) for one or more pins and may initialize one or more drivers (e.g., using configured strength values) at power-on. Additionally, or alternatively, the memory system may perform data training as part of power-on procedures. For example, data training may include duty cycle correction (DCC) (e.g., for RE_t and RE_c signals), read training (e.g., for DQ and DQS signals), write training at a receiver (e.g., a NAND memory device) side, and write training at a transmitter (e.g., a NAND controller) side.

In some examples, read training may include calibrating a delay in reading data to ensure that the data is read correctly. For example, during a read operation a memory device (e.g., a NAND memory device) may output a data signal (e.g., DQ signal) and a data strobe signal (e.g., a DQS_t signal, a DQS_c signal) that is used for latching data read from the memory device. In some instances, latching the data using synchronized data signals and data strobe signals may result in one or more errors being introduced into the data. By applying a proper delay to the DQS signal or to the DQ signal, however, a stable read may be achieved.

To train the proper delay, a memory system may initiate read training by issuing a command (e.g., a read DQ training command) and transmitting a logical unit number (LUN). The read training operation may delay, for example, the data strobe signal (e.g., DQS_t. DQS_c) to align the data signal with an edge (e.g., a rising edge, a falling edge) of the data strobe signal. However, a calibrated delay may change during the course of operating the memory device, which may result in (another) misalignment between the data strobe signal and the data signal. Moreover, performing read training at power-on may add undesirable latency to the memory system. Accordingly, a memory system configured to perform a read training operation to read data with a proper delay and mitigate undesirable latency may be desirable.

A memory system configured to perform a read training operation to read data with a proper delay and mitigate undesirable latency may be desirable. For example, a memory system described herein may be configured to perform read training during a read operation. In some instances, the memory system may receive a read command and may read a subset (e.g., a first subset) of data associated with the read command. The memory system may apply one or more delays to each byte of the first subset of data to determine a proper delay for reading data. That is, the memory system may apply one or more delays to each byte in order to determine whether the delay results in stable (or unstable) data and whether the delay aligns the data strobe signal and the data signal. Upon determining a delay that results in stable data and aligns the data strobe signal and the data signal, the memory system may read a subset (e.g., a second subset) of data associated with the read command using the delay. Performing read training in this manner may reduce the quantity of errors caused by misalignment in the data strobe signal and data signal and may mitigate undesirable latency that the memory system would otherwise incur when performing read training.

In addition to applicability in memory systems as described herein, techniques for read training for non-volatile memory may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by reducing the quantity of errors caused by misalignment in the data strobe signal and data signal and may mitigate undesirable latency that the memory system would otherwise incur when performing read training, among other benefits.

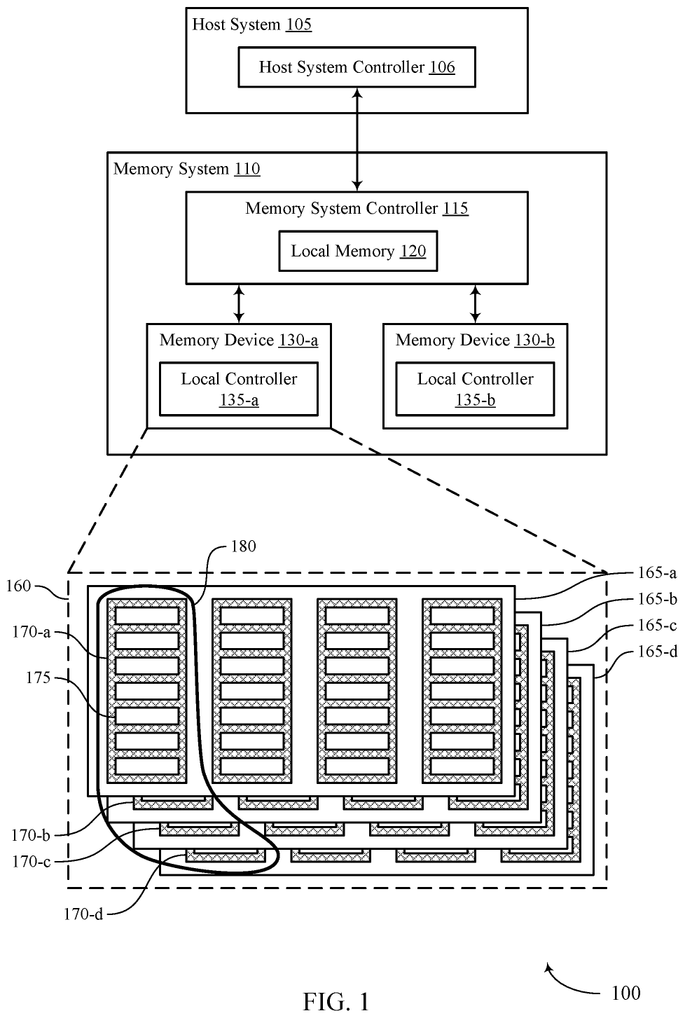

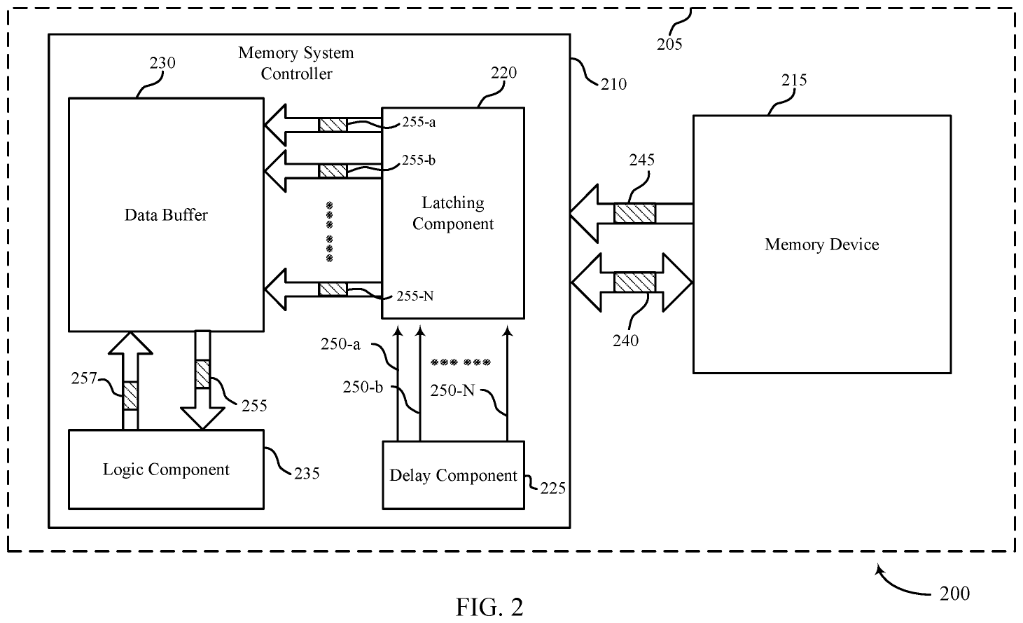

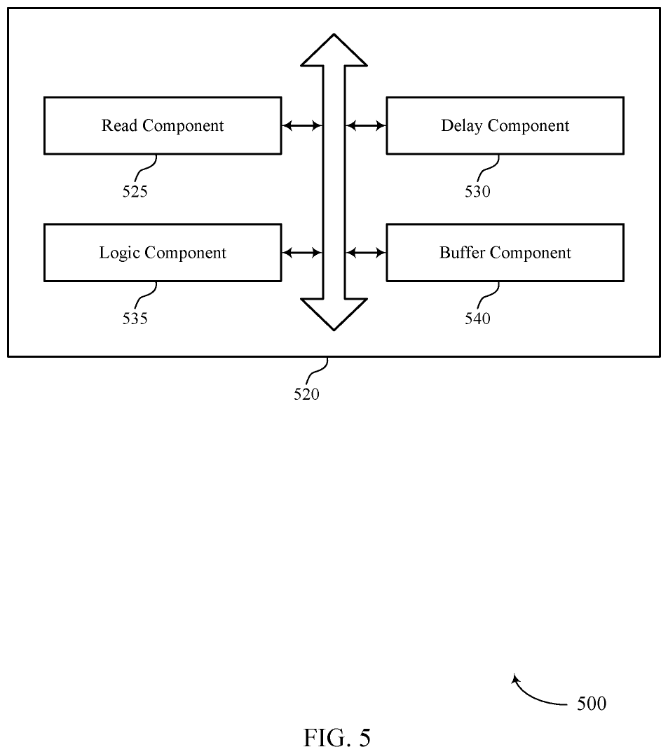

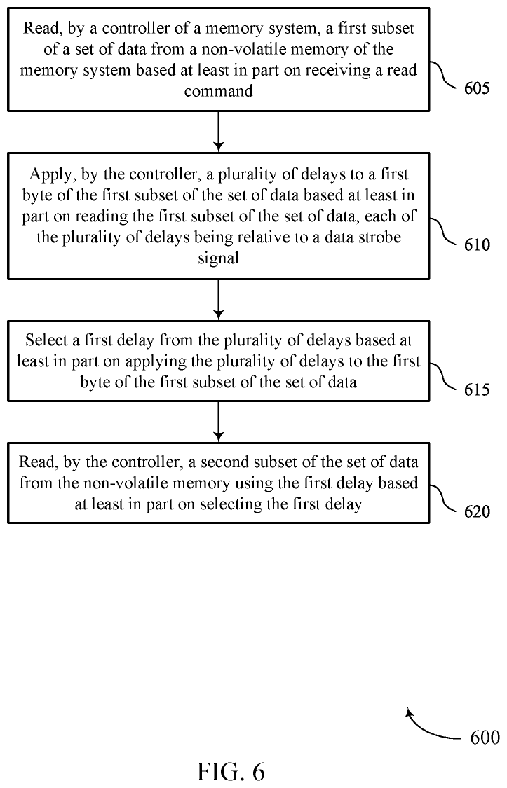

Features of the disclosure are initially described in the context of systems, devices, and circuits with reference to FIG. 1. Features of the disclosure are described in the context of block diagrams, timing diagrams, and process flows with reference to FIGS. 2 through 4. These and other features of the disclosure are further illustrated by and described in the context of an apparatus diagram and flowchart that relate to read training for non-volatile memory with reference to FIGS. 5 and 6.

FIG. 1 illustrates an example of a system 100 that supports read training for non-volatile memory in accordance with examples as disclosed herein. The system 100 includes a host system 105 coupled with a memory system 110.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other possibilities.

The system 100 may be included in a computing device such as a desktop computer, a laptop computer, a network server, a mobile device, a vehicle (e.g., airplane, drone, train, automobile, or other conveyance), an Internet of Things (IOT) enabled device, an embedded computer (e.g., one included in a vehicle, industrial equipment, or a networked commercial device), or any other computing device that includes memory and a processing device.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCle interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130-among other such operations-which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (mNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (RAM) (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170, and in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at the page level of granularity) but may be erased at a second level of granularity (e.g., at the block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (mNAND) system.

The system 100 may include any quantity of non-transitory computer readable media that support read training for non-volatile memory. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

The memory system 110 may be configured to perform read training during a read operation. In some instances, the memory system controller 115 may receive a read command and may read a subset (e.g., a first subset) of data (e.g., from the memory device 130) associated with the read command. The memory system controller 115 may apply one or more delays to each byte of the first subset of data to determine a proper delay for reading data. That is, the memory system controller 115 may apply one or more delays to each byte in order to determine whether the delay results in stable (or unstable) data and whether the delay aligns the data strobe signal and the data signal. Upon determining a delay that results in stable data and aligns the data strobe signal and the data signal, the memory system controller 115 may read a subset (e.g., a second subset) of data (e.g., from the memory device 130) associated with the read command using the delay. Performing read training in this manner may reduce the quantity of errors caused by misalignment in the data strobe signal and data signal and may mitigate undesirable latency that the memory system 110 would otherwise incur when performing read training.

FIG. 2 illustrates an example of a block diagram 200 that supports read training for non-volatile memory in accordance with examples as disclosed herein. In some examples, the block diagram 200 may implement aspects of a system 100 as described with reference to FIG. 1. For example, the block diagram 200 may include a memory system 205 which may be an example of a memory system 110 as described with reference to FIG. 1. Further, the memory system 205 may include a memory system controller 210 coupled with a memory device 215, which may represent a memory system controller 115 and a memory device 130, respectively, as described with reference to FIG. 1. In some cases, the memory system 205 may be coupled with and communicate with a host system (e.g., the host system 105) as described with reference to FIG. 1. The memory system 205 may be configured to perform read training on data read from the memory device 215, which may reduce the quantity of errors caused by misalignment in a data strobe signal and a data signal, and may mitigate undesirable latency that the memory system 205 would otherwise incur.

In some examples, the memory system controller 210 may include a latching component 220 coupled with a delay component 225, where the latching component 220 and the delay component 225 may be coupled with one or more inputs and outputs (e.g., one or more DQ or DQS pins, respectively). In some examples, the memory system controller 210 may include a data buffer 230 coupled with the latching component 220. The data buffer 230) may be coupled with a logic component 235. In some examples, the latching component, the data buffer 230, the logic component 235, and the delay component 225 may represent one or more circuits or components of the memory system controller 210, or one or more devices of the memory system 205, that are coupled with the memory system controller 210.

In some examples, data at the memory device 215 may be randomized. For example, in a previous write operation, the memory system controller 210 may scramble data (e.g., using a randomizer) before storing the data in memory cells of the memory device 215 (e.g., to attempt to store both Is and Os in memory cells with equal probability). Data scrambling (also referred to as “data randomization”) may be carried out, for example, by performing a bit-wise Exclusive-Or (XOR) between the data and a pseudo-random scrambling sequence. When stored, the scrambled data may be somewhat equally spread among different levels of the memory cells. Storage of scrambled data has a number of advantages, including the balancing of data-dependent cell wearing across the memory device 215, and enabling data to be used in training operations (e.g., read training).

In some examples, the memory system controller 210 may perform read training during a read operation as described herein. For example, in response to receiving a read command (e.g., from a host system), the memory system controller 210 may transmit one or more commands (e.g., a read change column command) to the memory device 215 via signal paths 240. In some cases, the memory system controller 210 may transmit a signal (e.g., RE_t and RE_c), and may adjust the signal to indicate to begin the read operation (e.g., RE_t may be brought high).

In response to the one or more commands, the memory device 215 may transmit a set of data to the memory system controller 210 via one or more signal paths 245. For example, the memory device 215 may read data associated with one or more LUNs and may transmit a DQ signal to the memory system controller 210 indicating a first subset of data (e.g., a first subset of the set of data). The first subset of data may include a quantity of bytes (e.g., M-bytes), which may represent a minimum quantity of data used for read training. In some examples, the quantity of bytes of the first subset of data may be configured by the memory system 205. In some cases, the memory device 215 may transmit the set of data using a double-data-rate (DDR).

In some examples, the memory system controller 210 may apply one or more delays 250 to the first subset of data relative to a data strobe signal (e.g., a DQS signal). For example, the delay component 225 may be configured with a quantity of delays (e.g., N delays), including delays 250-a through 250-N. The memory system controller 210 may latch each byte of data (e.g., of the first subset of data) using each delay 250. As described herein, the applied delays may result in the bytes of data being latched at different times relative to the data strobe signal. In some examples, the delay component 225 may indicate the delays 250-a through 250-N to the latching component 220, or the latching component 220 may receive the data strobe signal directly via the signal paths 240 (and may apply the respective delays accordingly). In some cases, the quantity and duration of the delays may be determined during a power-on procedure, may be configured at the memory system 205, may be user-defined, or a combination thereof.

After latching the bytes of the first subset of data according to the respective delays, the memory system controller 210 may store the bytes to the data buffer 230. For example, the latching component 220 may output bytes 255 to the data buffer 230, including bytes 255-a through 255-N, where the bytes 255 may represent a first byte of the first subset latched according to the delays 250-a through 250-N. For example, the byte 255-a may represent the first byte latched according to the delay 250-a, the byte 255-b may represent the first byte latched according to the delay 250-b, and the byte 255-N may represent the first byte latched according to the delay 250-N.

In some examples, a first delay (e.g., a “best” delay) may be selected for each byte. For example, after applying each delay 250 to a first byte, the memory system controller 210 may determine which delays 250 resulted in the first byte being stable. As used herein, “stable” data may refer to data associated with a voltage value that is commonly associated with a defined logic state (e.g., a “0)” or a “1”). For example, after applying a delay to a first byte, the byte may be associated with a first voltage value. If the first voltage value is within a range (e.g., within a threshold range) of a voltage value associated with a logic “0” or a logic “1”, then the first byte may be stable. Moreover, “unstable” data may refer to data associated with a voltage value that is not commonly associated with a defined logic state. For example, after applying a delay to a second byte, the byte may be associated with a second voltage value. If the second voltage value is not within a range (e.g., not within a threshold range) of a voltage value associated with a logic “0” or a logic “1”, then the first byte may be unstable. The memory system controller 210 may thus determine which bytes are stable by comparing the bytes 255-a through 255-N to an expected value for the first byte (e.g., ‘1’ or ‘0’).

After determining which bytes 255 are stable, the memory system controller 210 may select a delay associated with the first byte. For example, the logic component 235 may select a delay for the first byte by determining an average of the delays associated with stable data. That is, the logic component 235 may take an average of the delays that resulted in the first byte of data being stable. In other examples, the logic component 235 may select the delay by determining a median of the delays that resulted in the first byte of data being stable, or may select a midpoint (e.g., a midpoint value) of the delays. In other examples, if a single delay resulted in stable data, the logic component 235 may select the delay that resulted in the data being stable.

In some examples, the memory system controller 210 select a delay for each byte of the first subset of data using the methods described herein. For example, after selecting a delay for the first byte (e.g., using a midpoint, mean, median, or average value), the memory system controller 210 may select a delay for the additional bytes of the first subset of data using a same or similar method. After selecting a delay for each byte, the memory system controller 210 may select a “best” delay associated with the first subset of data. In some examples, the “best” delay (e.g., the first delay) may correspond to the most-common delay of the bytes. For example, the memory system controller 210 may determine that a first delay was selected for four bytes, a second delay was selected for two bytes, a third delay was selected for two bytes, and a fourth delay was selected for one byte. Accordingly, in such an example, the memory system controller 210 (e.g., the logic component 235) may select the first delay.

In some examples, an indication 257 of the first delay may be provided to the data buffer 230. For example, the logic component 235 may transmit an indication 257 of the first delay to the data buffer 230. In some examples, the memory system controller 210 may select a delay 250 after the data buffer 230 is full, or after storing each byte of the first subset of data to the data buffer 230.

In some examples, after selecting the first delay the memory system controller 210 may continue the read operation using the selected first delay. For example, the memory system controller 210 may read a second subset of data of the set of data from the memory device 215. In some examples, reading the second subset of data may include transmitting one or more commands to the memory device 215 via the signal paths 240 (e.g., RE_t may be brought high). The memory device 215 may transmit the second subset of data in response to the one or more commands. In some examples, the memory system controller 210 may latch one or more bytes of the second subset of data using the selected first delay. For example, the latching component 220 may receive the second subset of data (e.g., via one or more DQ pins) and may latch one or more bytes of the second subset of data according the selected first delay. In some instances, the latched bytes of the second subset of data may be stored to the data buffer 230. In some examples, storing the latched bytes of the second subset of data to the data buffer 230 may include overwriting data previously stored in the data buffer 230 (e.g., the bytes 255-a through 255-N). In some cases, bytes 255 saved to the data buffer 230 corresponding to the first delay.

In some examples, the memory system controller 210 may perform read training in response to determining a change in one or more operational parameters of the memory system 205. For example, a temperature of the memory system 205 may fall below a first threshold or rise above a second threshold, or a power supply of the memory system 205 may fall below a third threshold. In some cases, the memory system controller 210 may perform a read training operation in response to determining the change in temperature and/or power supply. In some examples, the memory system controller 210 may receive one or more messages indicating the change in temperature or power supply (e.g., from a host system), or may determine the changes within the memory system 205 (e.g., using the logic component 235) using one or more temperature values or power supply values (e.g., voltage, current, or power).

In some cases, the memory system controller 210 may perform the read training operations described herein for one or more read operations in response to one or more settings or configurations of the memory system 205. For example, the memory system controller 210 may perform read training during every read operation, during every-other read operation, or during one or more read operations at a certain periodicity. Additionally, or alternatively, the memory system controller 210 may perform read training dynamically in response to receiving one or more commands (e.g., from a host system). In some examples, the memory system controller 210 may perform read training after determining that a duty cycle (e.g., of the DQ signal or the DQS signal) has changed or after an average delay has changed. Accordingly, the memory system 205 may be configured to perform read training on data read from the memory device 215, which may reduce the quantity of errors caused by misalignment in a data strobe signal and a data signal, and may mitigate undesirable latency that the memory system 205 would otherwise incur.

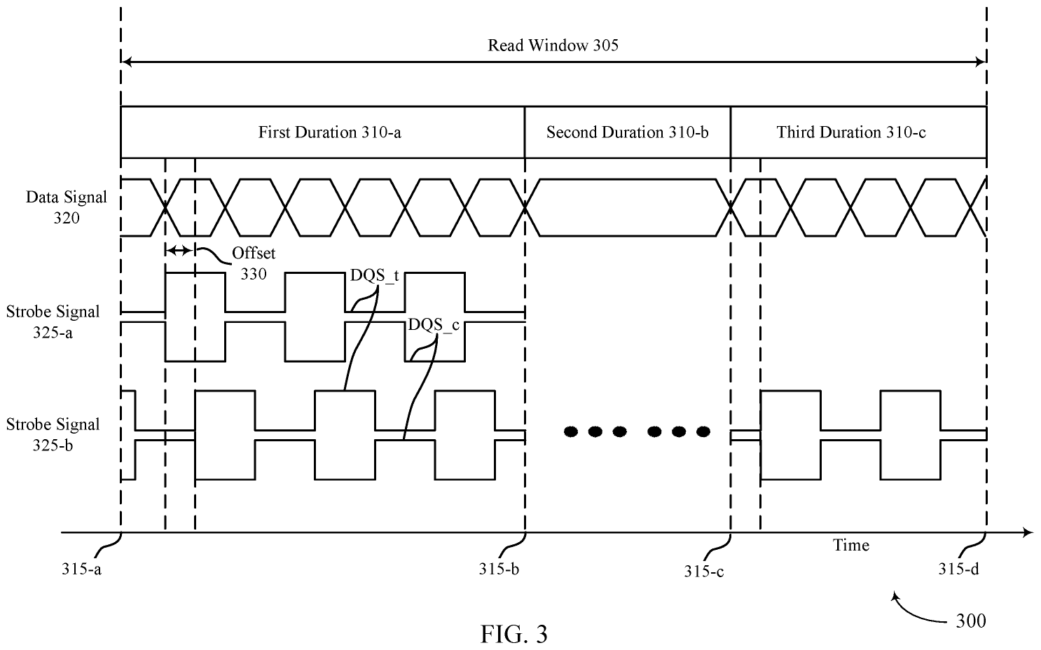

FIG. 3 illustrates an example of a timing diagram 300 that supports read training for non-volatile memory in accordance with examples as disclosed herein. In some examples, the timing diagram 300 may implement aspects of the system 100 as described with reference to FIG. 1 or the block diagram 200 as described with respect to FIG. 2. For example, the timing diagram 300 may represent timing for signaling during a read operation as described with reference to FIG. 2. In some instances, a read training operation may be performed during the read operation, which may reduce the quantity of errors caused by misalignment in a data strobe signal 325 and a data signal 320, and may mitigate undesirable latency that an associated memory system would otherwise incur.

In some examples, the read operation may include a read window 305 segmented into one or more durations 310, including a first duration 310-a, a second duration 310-b, and a third duration 310-c. In some examples, the read window 305 and the first duration 310-a for the read operation may begin at 315-a, the first duration 310-a may end and the second duration 310-b may begin at 315-b, the second duration 310-b may end and the third duration 310-c may begin at 315-c, and the third duration 310-c and the read window 305 may end at 315-d.

In some examples, a controller (e.g., a memory system controller 210 as described with reference to FIG. 2) may perform read training during the read window 305. For example, the controller may read a first subset of data during the first duration 310-a. In some examples, the controller may apply one or more delays to the bytes of the first subset of data by latching the bytes at different times relative to the data strobe signal 325.

In some examples, the controller and may select a first delay (e.g., a “best” delay) from one or more average delays during the second duration 310-b. After selecting the first delay, the controller may continue the read operation during the third duration 310-c (e.g., by bringing RE_t high at 315-c), and may read a second subset of data during the third duration 310-c using the selected delay (e.g., using the first delay).

In some examples, the controller may transmit signaling to a memory device to refrain from reading data during the second duration 310-b. For example, the controller may transmit an RE_t signal and an RE_c signal, where the controller 415 may bring the RE_t signal low to refrain from reading data during the second duration 310-b such that the controller may select a delay (e.g., a first delay) for reading the second subset of data with.

By way of example, the timing of the data strobe signal 325-a relative to the data signal 320 may represent an instance where data is read from a memory array using a delay that is, ultimately, not selected by memory system due to the likelihood of one or more errors may be introduced into the data. For example, the delay (or lack thereof) applied when reading the data may result in a portion of the data signal 320 being aligned with a rising edge, a falling edge, or both of the data strobe signal 325-a.

In other examples, the timing of the data strobe signal 325-b relative to the data signal 320 may represent an instance where data is read from a memory array using a first delay that is, ultimately, selected by memory system for reading the second subset of data. For example, a delay (e.g., a first delay) may be applied when reading the associated data, which may result in a portion of the data signal 320 being aligned with the data strobe signal 325-b. In some instances, the first delay may be illustrated by the offset 330. That is, the offset 330 may illustrate the duration of the first delay, which may result in the data being properly aligned with the data strobe signal 325-b.

Accordingly, in some instances, the controller may select the first delay during the second duration 310-b. Moreover, after selecting the first delay, the controller may read the second subset of data, using the first delay, during the third duration 310-c. After reading the second subset of data, the read command may be satisfied. Accordingly, the read training operation may be performed during the read window 305, which may reduce the quantity of errors caused by misalignment in a data strobe signal 325 and a data signal 320, and may mitigate undesirable latency that an associated memory system would otherwise incur.

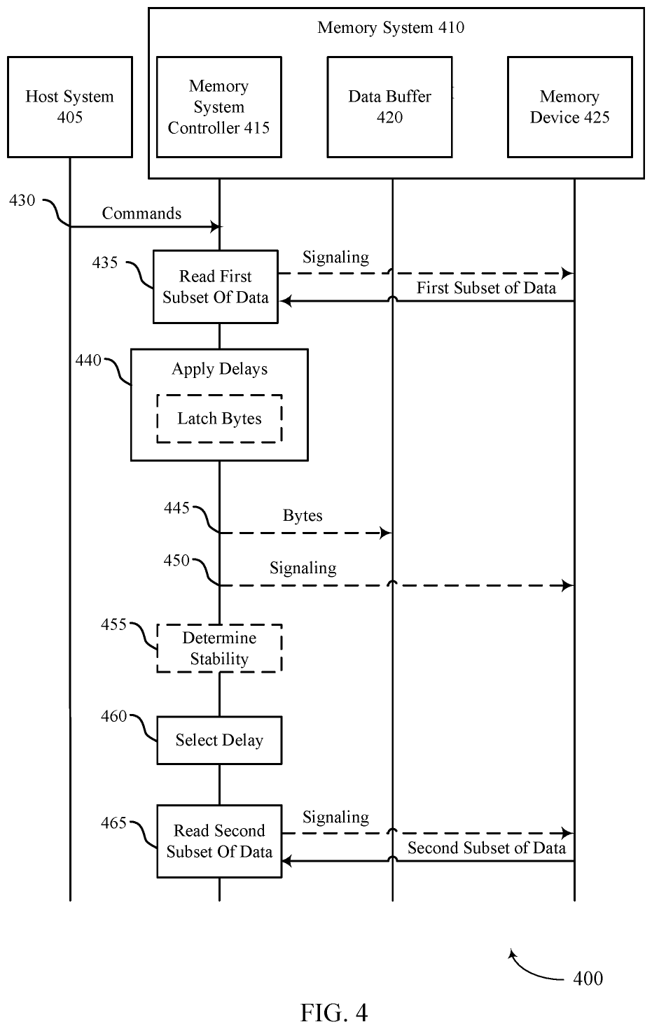

FIG. 4 illustrates an example of a process flow 400 that supports read training for non-volatile memory in accordance with examples as disclosed herein. In some examples, the process flow 400 may implement aspects of the system 100 as described with reference to FIG. 1, the block diagram 200 as described with respect to FIG. 2, or the timing diagram 300 as described with reference to FIG. 3. For example, the process flow 400 may include a host system 405 and a memory system 410, which may represent a host system 105, and a memory system 110 or a memory system 205, respectively, as described with reference to FIGS. 1 and 2. The memory system 410 may include a memory system controller 415, a data buffer 420, and a memory device 425, which may represent a memory system controller 115 or 210, a data buffer 230, and a memory device 130 or 215 as described with reference to FIGS. 1 and 2. The memory system 405 may be configured to perform read training on data read from the memory device 425, which may reduce the quantity of errors caused by misalignment in a data strobe signal and a data signal, and may mitigate undesirable latency that the memory system 405 would otherwise incur.

At 430, one or more commands may be received. For example, the host system 405 may transmit, and the memory system 410 (or the memory system controller 415) may receive, one or more read commands, write commands, or other commands associated with one or more operations performed at the memory system 410. In some examples, the host system 405 may transmit, and the memory system controller 415 may receive, a read command associated with a set of data, where the set of data may include a first subset and a second subset as described with reference to FIGS. 2 and 3. In some cases, the set of data may include randomized data as described with reference to FIG. 2.

At 435, a portion of a read operation may be performed. For example, the memory system controller 415 may initiate a read operation for the set of data, and the read operation may include a first duration, a second duration, and a third duration as described with reference to FIG. 3. In some examples, the memory system controller 415 may read the first subset of the set of data from the memory device 425 in response to receiving the read command. In some cases, reading the first subset of the set of data may include the memory device 425 transmitting the first subset of the set of data to the memory system controller 415. In some cases, the memory device 425 may transmit the first subset of the set of data in response to receiving signaling from the memory system controller 415 (e.g., a RE_t signal is brought high). In some examples, the memory system controller 415 may read the first subset of the set of data during the first duration.

At 440, one or more delays may be applied. For example, the memory system controller 415 may apply one or more delays to one or more bytes of the first subset of data after reading the first subset of data. In some examples, the memory system controller 415 may apply the one or more delays to a first byte, where each of the one or more delays may be relative to a data strobe signal. In some examples, applying the one or more delays to the first byte may include latching the first byte relative to the data strobe signal according to each delay.

At 445, one or more bytes may be stored. For example, the memory system controller 415 may store one or more bytes to the data buffer 420, where the one or more bytes may be associated with applying the one or more delays to the one or more bytes of the first subset of the set of data (e.g., the latched bytes). For example, the memory system controller 415 may store bytes from a latching component to the data buffer 420 as described with reference to FIG. 2.

At 450, signaling may be transmitted. For example, the memory system controller 415 may transmit signaling to the memory device 425 to refrain from reading additional data for a duration. In some examples, the memory system controller 415 may transmit an RE_t signal and an RE_c signal, where the memory system controller 415 may bring the RE_t signal low (e.g., for the second duration 310-b as described with reference to FIG. 3).

At 455, a stability of one or more bytes may be determined. For example, the memory system controller 415 may determine a stability of the one or more bytes stored to the data buffer 420. In some examples, the memory system controller 415 may determine that one or more bytes corresponding to the first byte and latched in accordance with the one or more delays is stable or unstable as described with reference to FIGS. 2 and 3. In some examples, the memory system controller may determine that a byte corresponding to the first byte and latched with the first delay is stable, and that a byte corresponding to the first byte and latched with a second delay is unstable as described with respect to FIG. 3.

At 460, a first delay may be selected. For example, the memory system controller 415 may select a first delay (e.g., a “best” delay) for reading the second subset of data. In some examples, the memory system controller 415 may select the first delay in response to determining that the byte latched with the first delay is stable and the byte latched with the second delay is unstable as described with reference to FIGS. 2 and 3. In some examples, the memory system controller 415 may select the first delay during the second duration. In some examples, the memory system controller 415 may select the first delay from one or more average delays corresponding to the bytes of the first subset, where the first delay may be a most common delay or selected from a median, mean, average, or median value. In some examples, the average delays may be selected after determining multiple stable delays across different bytes of the first subset of data.

At 465, a second subset of the set of data may be read. For example, the memory system controller 415 may read the second subset of data using the selected first delay. In some examples, the memory system controller 415 may exchange signaling with the memory device 425 indicating to resume reading data (e.g., may bring a RE_t signal high), may receive the second subset of data from the memory device 425, and may latch one or more bytes of the second subset relative to a data strobe signal in accordance with the first delay. In some cases, reading the second subset of data using the first delay may adjust a transmission of the second subset of the set of data over one or more channels of the memory system relative to a rising edge of the data strobe signal, a falling edge of the data strobe signal, or both, as described with reference to FIG. 3. Accordingly, by performing a read training operation as described herein, the memory system 405 may reduce the quantity of errors caused by misalignment in a data strobe signal and a data signal, and may mitigate undesirable latency that the memory system 405 would otherwise incur.

FIG. 5 illustrates a block diagram 500 of a generic device 520 that supports read training for non-volatile memory in accordance with examples as disclosed herein. The generic device 520 may be an example of aspects of a generic device as described with reference to FIGS. 1 through 4. The generic device 520, or various components thereof, may be an example of means for performing various aspects of read training for non-volatile memory as described herein. For example, the generic device 520 may include a read component 525, a delay component 530, a logic component 535, a buffer component 540, or any combination thereof. Each of these components may communicate, directly or indirectly, with one another (e.g., via one or more buses).

The read component 525 may be configured as or otherwise support a means for reading, by a controller of a memory system, a first subset of a set of data from a non-volatile memory of the memory system based at least in part on receiving a read command. The delay component 530 may be configured as or otherwise support a means for applying, by the controller, a plurality of delays to a first byte of the first subset of the set of data based at least in part on reading the first subset of the set of data, each of the plurality of delays being relative to a data strobe signal. The logic component 535 may be configured as or otherwise support a means for selecting a first delay from the plurality of delays based at least in part on applying the plurality of delays to the first byte of the first subset of the set of data. In some examples, the read component 525 may be configured as or otherwise support a means for reading, by the controller, a second subset of the set of data from the non-volatile memory using the first delay based at least in part on selecting the first delay.

In some examples, the delay component 530 may be configured as or otherwise support a means for applying the plurality of delays to each byte of the first subset of the set of data based at least in part on reading the first subset of the set of data, where selecting the first delay from the plurality of delays is based at least in part on applying the plurality of delays to each byte.

In some examples, the logic component 535 may be configured as or otherwise support a means for determining that the first byte of the first subset of the set of data is stable based at least in part on applying the first delay to the first byte, where selecting the first delay from the plurality of delays is based at least in part on determining that the first byte is stable.

In some examples, the logic component 535 may be configured as or otherwise support a means for determining that the first byte of the first subset of the set of data is unstable based at least in part on applying a second delay to the first byte, where selecting the first delay from the plurality of delays is based at least in part on determining that the first byte is unstable based at least in part on applying the second delay.

In some examples, to support selecting the first delay from the plurality of delays, the logic component 535 may be configured as or otherwise support a means for determining one or more delays of the plurality of delays that result in the first byte being stable based at least in part on applying the plurality of delays. In some examples, to support selecting the first delay from the plurality of delays, the logic component 535 may be configured as or otherwise support a means for selecting an average delay of the one or more delays that result in the first byte being stable.

In some examples, the first subset of the set of data is read during a first duration. In some examples, the plurality of delays are applied to the first byte of the first subset of the set of data and the first delay is selected during a second duration. In some examples, the second subset of the set of data is read during a third duration. In some examples, a read operation associated with the read command includes the first duration, the second duration, and the third duration.

In some examples, to support applying the plurality of delays to the first byte of the first subset of the set of data, the delay component 530 may be configured as or otherwise support a means for latching the first byte according to each delay of the plurality of delays, where each the first byte is latched relative to the data strobe signal. For example, the delay component may include a delay component and a latching component.

In some examples, the buffer component 540 may be configured as or otherwise support a means for storing, to a buffer of the memory system, a plurality of first bytes based at least in part on latching the first byte according to each delay of the plurality of delays, where selecting the first delay from the plurality of delays is based at least in part on storing the plurality of first bytes to the buffer.

In some examples, the plurality of delays are applied to the first byte of the first subset of the set of data based at least in part on a change in one or more operational parameters of the memory system.

In some examples, reading the second subset of the set of data from the non-volatile memory using the first delay adjusts a transmission of the second subset of the set of data over one or more channels of the memory system relative to a rising edge of the data strobe signal, a falling edge of the data strobe signal, or both. In some examples, the set of data includes randomized data. In some examples, the read command is for the set of data.

FIG. 6 illustrates a flowchart showing a method 600 that supports read training for non-volatile memory in accordance with examples as disclosed herein. The operations of method 600 may be implemented by a generic device or its components as described herein. For example, the operations of method 600 may be performed by a generic device as described with reference to FIGS. 1 through 5. In some examples, a generic device may execute a set of instructions to control the functional elements of the device to perform the described functions. Additionally, or alternatively, the generic device may perform aspects of the described functions using special-purpose hardware.

At 605, the method may include reading, by a controller of a memory system, a first subset of a set of data from a non-volatile memory of the memory system based at least in part on receiving a read command. The operations of 605 may be performed in accordance with examples as disclosed herein. In some examples, aspects of the operations of 605 may be performed by a read component 525 as described with reference to FIG. 5.

At 610, the method may include applying, by the controller, a plurality of delays to a first byte of the first subset of the set of data based at least in part on reading the first subset of the set of data, each of the plurality of delays being relative to a data strobe signal. The operations of 610 may be performed in accordance with examples as disclosed herein. In some examples, aspects of the operations of 610 may be performed by a delay component 530 as described with reference to FIG. 5.

At 615, the method may include selecting a first delay from the plurality of delays based at least in part on applying the plurality of delays to the first byte of the first subset of the set of data. The operations of 615 may be performed in accordance with examples as disclosed herein. In some examples, aspects of the operations of 615 may be performed by a logic component 535 as described with reference to FIG. 5.

At 620, the method may include reading, by the controller, a second subset of the set of data from the non-volatile memory using the first delay based at least in part on selecting the first delay. The operations of 620 may be performed in accordance with examples as disclosed herein. In some examples, aspects of the operations of 620 may be performed by a read component 525 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for reading, by a controller of a memory system, a first subset of a set of data from a non-volatile memory of the memory system based at least in part on receiving a read command: applying, by the controller, a plurality of delays to a first byte of the first subset of the set of data based at least in part on reading the first subset of the set of data, each of the plurality of delays being relative to a data strobe signal: selecting a first delay from the plurality of delays based at least in part on applying the plurality of delays to the first byte of the first subset of the set of data: and reading, by the controller, a second subset of the set of data from the non-volatile memory using the first delay based at least in part on selecting the first delay.
Aspect 2: The method, apparatus, or non-transitory computer-readable medium of aspect 1, further including operations, features, circuitry, logic, means, or instructions, or any combination thereof for applying the plurality of delays to each byte of the first subset of the set of data based at least in part on reading the first subset of the set of data, where selecting the first delay from the plurality of delays is based at least in part on applying the plurality of delays to each byte.
Aspect 3: The method, apparatus, or non-transitory computer-readable medium of any of aspects 1 through 2, further including operations, features, circuitry, logic, means, or instructions, or any combination thereof for determining that the first byte of the first subset of the set of data is stable based at least in part on applying the first delay to the first byte, where selecting the first delay from the plurality of delays is based at least in part on determining that the first byte is stable.
Aspect 4: The method, apparatus, or non-transitory computer-readable medium of aspect 3, further including operations, features, circuitry, logic, means, or instructions, or any combination thereof for determining that the first byte of the first subset of the set of data is unstable based at least in part on applying a second delay to the first byte, where selecting the first delay from the plurality of delays is based at least in part on determining that the first byte is unstable based at least in part on applying the second delay.
Aspect 5: The method, apparatus, or non-transitory computer-readable medium of any of aspects 1 through 4, where selecting the first delay from the plurality of delays includes operations, features, circuitry, logic, means, or instructions, or any combination thereof for determining one or more delays of the plurality of delays that result in the first byte being stable based at least in part on applying the plurality of delays and selecting an average delay of the one or more delays that result in the first byte being stable.
Aspect 6: The method, apparatus, or non-transitory computer-readable medium of any of aspects 1 through 5, where the first subset of the set of data is read during a first duration: the plurality of delays are applied to the first byte of the first subset of the set of data and the first delay is selected during a second duration: and the second subset of the set of data is read during a third duration.
Aspect 7: The method, apparatus, or non-transitory computer-readable medium of aspect 6, where a read operation associated with the read command includes the first duration, the second duration, and the third duration.
Aspect 8: The method, apparatus, or non-transitory computer-readable medium of any of aspects 1 through 7, where applying the plurality of delays to the first byte of the first subset of the set of data includes operations, features, circuitry, logic, means, or instructions, or any combination thereof for latching the first byte according to each delay of the plurality of delays, where each the first byte is latched relative to the data strobe signal.
Aspect 9: The method, apparatus, or non-transitory computer-readable medium of aspect 8, further including operations, features, circuitry, logic, means, or instructions, or any combination thereof for storing, to a buffer of the memory system, a plurality of first bytes based at least in part on latching the first byte according to each delay of the plurality of delays, where selecting the first delay from the plurality of delays is based at least in part on storing the plurality of first bytes to the buffer.
Aspect 10: The method, apparatus, or non-transitory computer-readable medium of any of aspects 1 through 9, where the plurality of delays are applied to the first byte of the first subset of the set of data based at least in part on a change in one or more operational parameters of the memory system.
Aspect 11: The method, apparatus, or non-transitory computer-readable medium of any of aspects 1 through 10, where reading the second subset of the set of data from the non-volatile memory using the first delay adjusts a transmission of the second subset of the set of data over one or more channels of the memory system relative to a rising edge of the data strobe signal, a falling edge of the data strobe signal, or both.
Aspect 12: The method, apparatus, or non-transitory computer-readable medium of any of aspects 1 through 11, where the set of data includes randomized data.
Aspect 13: The method, apparatus, or non-transitory computer-readable medium of any of aspects 1 through 12, where the read command is for the set of data.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal: however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” refers to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow:

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a memory device; and
a controller coupled with the memory device and configured to cause the apparatus to:
read a first subset of a set of data from a non-volatile memory of the memory device based at least in part on receiving a read command;
apply a plurality of delays to a first byte of the first subset of the set of data based at least in part on reading the first subset of the set of data, each of the plurality of delays being relative to a data strobe signal;
select a first delay from the plurality of delays based at least in part on applying the plurality of delays to the first byte of the first subset of the set of data; and
read a second subset of the set of data from the non-volatile memory using the first delay based at least in part on selecting the first delay.

2. The apparatus of claim 1, wherein the controller is further configured to cause the apparatus to:
apply the plurality of delays to each byte of the first subset of the set of data based at least in part on reading the first subset of the set of data, wherein selecting the first delay from the plurality of delays is based at least in part on applying the plurality of delays to each byte.

3. The apparatus of claim 1, wherein the controller is further configured to cause the apparatus to:
determine that the first byte of the first subset of the set of data is stable based at least in part on applying the first delay to the first byte, wherein selecting the first delay from the plurality of delays is based at least in part on determining that the first byte is stable.

4. The apparatus of claim 3, wherein the controller is further configured to cause the apparatus to:
determine that the first byte of the first subset of the set of data is unstable based at least in part on applying a second delay to the first byte, wherein selecting the first delay from the plurality of delays is based at least in part on determining that the first byte is unstable based at least in part on applying the second delay.

5. The apparatus of claim 1, wherein, to select the first delay from the plurality of delays, the controller is configured to cause the apparatus to:
determine one or more delays of the plurality of delays that result in the first byte being stable based at least in part on applying the plurality of delays; and
select an average delay of the one or more delays that result in the first byte being stable.

6. The apparatus of claim 1, wherein:
the first subset of the set of data is read during a first duration:
the plurality of delays are applied to the first byte of the first subset of the set of data and the first delay is selected during a second duration; and
the second subset of the set of data is read during a third duration.

7. The apparatus of claim 6, wherein a read operation associated with the read command comprises the first duration, the second duration, and the third duration.

8. The apparatus of claim 1, wherein, to apply the plurality of delays to the first byte of the first subset of the set of data, the controller is configured to cause the apparatus to:
latch the first byte according to each delay of the plurality of delays, wherein each the first byte is latched relative to the data strobe signal.

9. The apparatus of claim 8, wherein the controller is further configured to cause the apparatus to:
store, to a buffer of the memory device, a plurality of first bytes based at least in part on latching the first byte according to each delay of the plurality of delays, wherein selecting the first delay from the plurality of delays is based at least in part on storing the plurality of first bytes to the buffer.

10. The apparatus of claim 1, wherein the plurality of delays are applied to the first byte of the first subset of the set of data based at least in part on a change in one or more operational parameters of the memory device.

11. The apparatus of claim 1, wherein reading the second subset of the set of data from the non-volatile memory using the first delay adjusts a transmission of the second subset of the set of data over one or more channels of the memory device relative to a rising edge of the data strobe signal, a falling edge of the data strobe signal, or both.

12. The apparatus of claim 1, wherein the set of data comprises randomized data.

13. The apparatus of claim 1, wherein the read command is for the set of data.

14. A non-transitory computer-readable medium storing code comprising instructions which, when executed by a processor of an electronic device, cause the electronic device to:
read, by a controller of a memory system, a first subset of a set of data from a non-volatile memory of the memory system based at least in part on receiving a read command:
apply, by the controller, a plurality of delays to a first byte of the first subset of the set of data based at least in part on reading the first subset of the set of data, each of the plurality of delays being relative to a data strobe signal;
select a first delay from the plurality of delays based at least in part on applying the plurality of delays to the first byte of the first subset of the set of data; and
read, by the controller, a second subset of the set of data from the non-volatile memory using the first delay based at least in part on selecting the first delay.

15. The non-transitory computer-readable medium of claim 14, wherein the instructions, when executed by the processor of the electronic device, further cause the electronic device to:
apply the plurality of delays to each byte of the first subset of the set of data based at least in part on reading the first subset of the set of data, wherein selecting the first delay from the plurality of delays is based at least in part on applying the plurality of delays to each byte.

16. The non-transitory computer-readable medium of claim 14, wherein the instructions, when executed by the processor of the electronic device, further cause the electronic device to:
determine that the first byte of the first subset of the set of data is stable based at least in part on applying the first delay to the first byte, wherein selecting the first delay from the plurality of delays is based at least in part on determining that the first byte is stable.

17. The non-transitory computer-readable medium of claim 16, wherein the instructions, when executed by the processor of the electronic device, further cause the electronic device to:
determine that the first byte of the first subset of the set of data is unstable based at least in part on applying a second delay to the first byte, wherein selecting the first delay from the plurality of delays is based at least in part on determining that the first byte is unstable based at least in part on applying the second delay.

18. The non-transitory computer-readable medium of claim 14, wherein to select the first delay from the plurality of delays the instructions, when executed by the processor of the electronic device, cause the electronic device to:
determine one or more delays of the plurality of delays that result in the first byte being stable based at least in part on applying the plurality of delays; and
select an average delay of the one or more delays that result in the first byte being stable.

19. A method, comprising:
reading, by a controller of a memory system, a first subset of a set of data from a non-volatile memory of the memory system based at least in part on receiving a read command;
applying, by the controller, a plurality of delays to a first byte of the first subset of the set of data based at least in part on reading the first subset of the set of data, each of the plurality of delays being relative to a data strobe signal;
selecting a first delay from the plurality of delays based at least in part on applying the plurality of delays to the first byte of the first subset of the set of data; and
reading, by the controller, a second subset of the set of data from the non-volatile memory using the first delay based at least in part on selecting the first delay.

20. The method of claim 19, further comprising:
applying the plurality of delays to each byte of the first subset of the set of data based at least in part on reading the first subset of the set of data, wherein selecting the first delay from the plurality of delays is based at least in part on applying the plurality of delays to each byte.
